(19) United States
(12) Patent Application Publication
(10) Pub. No.: US 2005/0084737 A1
(43) Pub. Date: Apr. 21, 2005

(54) Fuel cells having cross directional laminar flowstreams

(76) Inventors: David W. Wine, Seattle, WA (US); Leroy J. Ohlsen, Gold Bar, WA (US)

Correspondence Address: THOMAS E. LOOP;BARNARD, LOOP & MCCORMACK, 947 POWELL AVENUE SW, SUITE 105, RENTON, WA, 98055, US

(21) Appl. No.: 10/892,876

(22) Filed: Jul. 16, 2004

Related U.S. Application Data
(60) Provisional application No. 60/513,248, filed on Oct. 20, 2003.

(51) Int. Cl. H01M 8/02; H01M 8/20

(52) U.S. Cl. 429/38; 429/105

(57) ABSTRACT

The invention disclosed herein relates to fuel cell and electrochemical cells having internal multistream laminar flow and, more specifically, to microfluidic fuel cell and electrochemical cells having two or more adjacent and cross-flowing (i.e., non-parallel) laminar flowstreams positioned within an electrode pair assembly. In one embodiment, an electrochemical cell is disclosed that comprises: a first electrode; a second electrode that opposes the first electrode; and a channel or plenum interposed between and contiguous with at least a portion of the first and second electrodes. The electrochemical cell of this embodiment is configured such that a first fluid enters the channel or plenum and laminarly flows adjacent to the first electrode in a first flow direction, and a second fluid enters the channel or plenum and laminarly flows adjacent to the second electrode in a second flow direction, wherein the first and second flow directions are different from each other.

### CROSS-REFERENCE TO RELATED APPLICATION

This application claims the benefit of U.S. Provisional Application No. 60/513,248 filed on Oct. 20, 2003, which application is incorporated herein by reference in its entirety for all purposes.

### GOVERNMENT RIGHTS

This invention was made with United States Government support under Advanced Technology Program Award Number 70NANB3H3036 awarded by the National Institute of Standards and Technology (NIST). The United States Government has certain rights in the invention.

### TECHNICAL FIELD

The present invention is directed to electrochemical and fuel cell systems having internal laminar flowstreams and, more specifically, to microfluidic electrochemical and fuel cell systems having two or more adjacent and cross-flowing (i.e., non-parallel) laminar flowstreams positioned within a flow cell of an electrode pair assembly.

### BACKGROUND OF THE INVENTION

A fuel cell is an energy conversion device that consists essentially of two opposing electrodes, an anode and a cathode, ionically connected together via an interposing electrolyte. An electrochemical cell also includes two opposing electrodes; however, it may operate either (1) as a fuel cell and thereby generate an electric current, or (2) as an electrolysis cell and thereby consume an electric current from an outside source (as the cell converts reactants into reaction byproducts). Unlike a battery, fuel cell reactants are supplied externally rather than internally. Fuel cells operate by converting fuels, such as hydrogen or a simple hydrocarbon (e.g., methanol), to electrical power through an electrochemical process rather than combustion. It does so by harnessing the electrons released from controlled oxidation-reduction reactions occurring on the surface of a catalyst. A fuel cell can produce electricity continuously so long as fuel and oxidant are supplied from an outside source.

In conventional electrochemical fuel cells employing methanol as the fuel supplied to the anode (also commonly referred to as a “Direct Methanol Fuel Cell (DMFC)”), the electrochemical reactions that occur are essentially as follows: first, a methanol molecule's carbon-hydrogen, and oxygen-hydrogen bonds are broken to generate electrons and protons; simultaneously, a water molecule's oxygen-hydrogen bond is also broken to generate an additional electron and proton. The carbon from the methanol and the oxygen from the water combine to form carbon dioxide. Oxygen from air (supplied to the cathode) is likewise simultaneously reduced at the cathode. The ions (protons) formed at the anode migrate through the interposing electrolyte and combine with the oxygen at the cathode to form water. The free electrons produced at the anode are routed via an external load to the cathode thereby completing the circuit. From a molecular perspective, the electrochemical reactions occurring within conventional direct methanol fuel cell (DMFC) systems are as follows:

$$\frac{\begin{matrix}Anode \text{:} & {CH}_{3} OH + {H}_{2} O \to 6 {H}^{+} + 6 {e}^{-} + {CO}_{2} & {E}_{0} = 0.04 V & vs . & NHE \\ Cathode \text{:} & \frac{3}{2} {O}_{2} + 6 {H}^{+} + 6 {e}^{-} \to 3 {H}_{2} O & {E}_{0} = 1.23 V & vs . & NHE\end{matrix}}{\begin{matrix}Net \text{:} & {CH}_{3} OH + \frac{3}{2} {O}_{2} \to 2 {H}_{2} O + {CO}_{2} & {E}_{0} = 1.24 V & vs . & NHE\end{matrix}} \qquad \begin{matrix}\begin{matrix}( 1 ) \\ ( 2 )\end{matrix} \\ ( 3 )\end{matrix}$$

The various electrochemical reactions associated with other state-of-the-art fuel cell systems (e.g., hydrogen or carbonaceous fuel) are likewise well known to those skilled in the art.

With respect to state-of-the-art fuel cell systems generally, several different configurations and structures have been contemplated—most of which are still undergoing further research and development. In this regard, existing fuel cell systems are typically classified based on one or more criteria, such as, for example: (1) the type of fuel and/or oxidant used by the system, (2) the type of electrolyte used in the electrode stack assembly, (3) the steady-state operating temperature of the electrode stack assembly, and (4) whether the fuel is processed outside (external reforming) or inside (internal reforming) the electrode stack assembly. In general, however, it is perhaps most customary to classify existing fuel cell systems by the type of electrolyte (i.e., ion conducting media) employed within the electrode stack assembly. Accordingly, most state-of-the-art fuel cell systems have been classified into one of the following known groups:
1. Alkaline fuel cells (e.g., KOH electrolyte);
2. Acid fuel cells (e.g., phosphoric acid electrolyte);
3. Molten carbonate fuel cells (e.g., Li₂CO₃/K₂CO₃ electrolyte);
4. Solid oxide fuel cells (e.g., yttria-stabilized zirconia electrolyte);
5. Proton exchange membrane fuel cells (e.g., NAFION electrolyte).

Although these state-of-the-art fuel cell systems are known to have many diverse structural and operational characteristics, such systems nevertheless share many common fuel, oxidant and reaction byproducts (i e., delivery and removal) flowstream design characteristics. Unfortunately, existing state-of-the-art fuel, oxidant and reaction byproducts flow regimes are not entirely satisfactory for the production of small-scale portable direct feed fuel cell systems, especially in view of problems associated with reactant (e.g., methanol) “cross-over.” Accordingly, there is still a need in the art for new and improved fuel and electrochemical cells that have, among other things, improved fuel, oxidant, and reaction byproduct flow regimes to thereby enable better utilization of the cells' supply of reactants (i.e., fuel and oxidants). The present invention fulfills these needs and provides for further related advantages.

### BRIEF DESCRIPTION OF THE DRAWINGS

The drawings are intended to be illustrative and symbolic representations of certain exemplary embodiments of the present invention and as such they are not necessarily drawn to scale.

FIG. 1 illustrates a side view of a portion of an electrode pair assembly having a Y-shaped channel, wherein the Y-shaped channel allows for two laminar flowstreams to be selectively flowed and positioned within a spaced apart region (e.g., a channel or plenum) in accordance with an embodiment of the present invention.

FIG. 2 illustrates an exploded side pictorial view of a portion of an electrochemical cell in accordance with an embodiment of the present invention, wherein the cell is configured such that a first fluid enters a channel or plenum and laminarly flows adjacent to a first electrode in a first flow direction, and a second fluid enters the channel or plenum and laminarly flows adjacent to a second electrode in a second flow direction, and wherein the first and second flow directions are different from each other.

FIG. 3A illustrates a top plan view of the portion of the electrochemical cell depicted in FIG. 2, wherein the cell is configured to have a single outlet zone in accordance with an embodiment of the present invention. This drawing also illustrates by way of arrows the average directional flow vector or profile associated with the anolyte and catholyte flowstreams.

FIG. 3B illustrates a top plan view of the portion of the electrochemical cell depicted in FIG. 2, wherein the cell is configured to have two outlet zones in accordance with an alternative embodiment of the present invention. This drawing also illustrates by way of arrows the average directional flow vector or profile associated with the anolyte and catholyte flowstreams.

FIG. 4A illustrates a side view of the portion of the electrochemical cell depicted in FIGS. 2 and 3A taken along line 4A-4A of FIG. 3A.

FIG. 4B illustrates a side view of the portion of the electrochemical cell depicted in FIGS. 2 and 3B taken along line 4B-4B of FIG. 3B.

FIG. 5A illustrates a side view of the portion of the electrochemical cell depicted in FIGS. 2, 3A and 4A taken along line 5A-5A of FIG. 3A.

FIG. 5B illustrates a side view of the portion of the electrochemical cell depicted in FIGS. 2, 3B and 4B taken along line 5B-5B of FIG. 3B.

FIG. 6 illustrates a side view of a portion of an electrode pair assembly having a Ψ-shaped channel, wherein the Ψ-shaped channel allows for three laminar flowstreams to be selectively flowed and positioned within a spaced apart region (e.g., a channel or plenum) in accordance with an embodiment of the present invention.

FIG. 7 illustrates an exploded side pictorial view of a portion of an electrochemical cell in accordance with an embodiment of the present invention, wherein the cell is configured such that a first fluid enters a channel or plenum and laminarly flows adjacent to a first electrode in a first flow direction, a second fluid enters the channel or plenum and laminarly flows adjacent to a second electrode in a second flow direction, and a third fluid enters the channel or plenum and laminarly flows between the first and second fluids, and wherein at least the first and second flow directions are different from each other.

FIG. 8A illustrates a top plan view of the portion of the electrochemical cell depicted in FIG. 7, wherein the cell is configured to have a single outlet zone in accordance with an embodiment of the present invention. This drawing also illustrates by way of arrows the average directional flow vector or profile associated with the anolyte, electrolyte, and catholyte flowstreams.

FIG. 8B illustrates a top plan view of the portion of the electrochemical cell depicted in FIG. 7, wherein the cell is configured to have two outlet zones in accordance with an alternative embodiment of the present invention. This drawing also illustrates by way of arrows the average directional flow vector or profile associated with the anolyte, electrolyte, and catholyte flowstreams.

FIG. 9A illustrates a side view of the portion of the electrochemical cell depicted in FIGS. 7 and 8A taken along line 9A-9A of FIG. 8A.

FIG. 9B illustrates a side view of the portion of the electrochemical cell depicted in FIGS. 7 and 8B taken along line 9B-9B of FIG. 8B.

FIG. 10A illustrates a side view of the portion of the electrochemical cell depicted in FIGS. 7, 8A and 9A taken along line 10A-10A of FIG. 8A.

FIG. 10B illustrates a side view of the portion of the electrochemical cell depicted in FIGS. 7, 8B and 9B taken along line 10B-10B of FIG. 8B.

FIG. 11 illustrates an exploded side pictorial view of a portion of a fuel cell in accordance with an embodiment of the present invention, wherein the cell comprises a first flow-through electrode; a second flow-through electrode spaced apart from the first flow-through electrode; a plenum interposed between and contiguous with at least a portion of the first and second flow-through electrodes; a first fluid that passes through the first flow-through electrode and into the plenum, wherein the first fluid laminarly flows adjacent to the first electrode in a first flow direction; and a second fluid that passes through the second flow-through electrode and into the plenum, wherein second fluid laminarly flows adjacent to the second electrode in a second flow direction, and wherein the first and second flow directions are different from each other.

FIG. 12A illustrates a top plan view of the portion of the fuel cell depicted in FIG. 11, wherein the cell is configured to have a single outlet zone in accordance with an embodiment of the present invention.

FIG. 12B illustrates a top plan view of the portion of the fuel cell depicted in FIG. 11, wherein the cell is configured to have two outlet zones in accordance with an alternative embodiment of the present invention.

FIG. 13A illustrates a side view of the portion of the fuel cell depicted in FIGS. 11 and 12A taken along line 13A-13A of FIG. 12A.

FIG. 13B illustrates a side view of the portion of the fuel cell depicted in FIGS. 11 and 12B taken along line 13B-13B of FIG. 12B.

FIG. 14A illustrates a side view of the portion of the fuel cell depicted in FIGS. 11, 12A and 13A taken along line 14A-14A of FIG. 12A.

FIG. 14B illustrates a side view of the portion of the fuel cell depicted in FIGS. 11, 12B and 13B taken along line 14B-14B of FIG. 12B.

FIG. 15A is a pictorial view of an exemplary prototype fuel cell assembly adapted to flow an anolyte flowstream through and adjacent to a first electrode, and a catholyte flowstream through and adjacent to a second electrode in accordance with an embodiment of the present invention. The fuel cell assembly is drawn to scale and represents a configuration useful for purposes of testing and design validation.

FIG. 15B is an exploded view of the fuel cell assembly shown in FIG. 15A, wherein arrows represent generalized flow paths associated with the anolyte and catholyte flowstreams.

FIG. 16A is a graph showing predicted and actual polarization curves and power density curves associated with an electrode pair assembly (i.e., 2-cell stack) in accordance with an embodiment of the present invention.

FIG. 16B is a graph showing predicted and actual polarization curves and power density curves associated with an electrode stack assembly (i.e., 4-cell stack) in accordance with an embodiment of the present invention.

### SUMMARY OF THE INVENTION

In brief, the present invention is directed to fuel and electrochemical cells having two or more adjacent and cross-flowing (i.e., non-parallel) laminar flowstreams positioned within an electrode pair assembly. In one embodiment, the present invention is directed to an electrochemical cell that comprises: a first electrode; a second electrode that opposes the first electrode; and a channel or plenum interposed between and contiguous with at least a portion of the first and second electrodes. The electrochemical cell of this embodiment is configured such that a first fluid enters the channel or plenum and laminarly flows adjacent to the first electrode in a first flow direction, and a second fluid enters the channel or plenum and laminarly flows adjacent to the second electrode in a second flow direction, wherein the first and second flow directions are different from each other. In this embodiment, the first and second fluids may contact each other to define an interface as the first and second fluids laminarly flow within the channel or plenum. Alternatively, the electrochemical cell may further comprise a separator positioned between the first fluid laminarly flowing adjacent to the first electrode and the second fluid laminarly flowing adjacent to the second electrode. The separator may be a metallic membrane or a polymeric membrane. In addition, the first and second flow directions may range from being perpendicular to each other to being substantially parallel or parallel to each other.

In other embodiments, the first fluid laminarly flowing adjacent to the first electrode has a first flow velocity, and the second fluid laminarly flowing adjacent to the second electrode has a second flow velocity, and wherein the first and second flow velocities are different from each other. In still other embodiments, the electrochemical cell may further comprise a third fluid that laminarly flows between the first and second fluids, wherein the third flow direction is the same or different than the first flow direction. The third fluid flow has a third flow velocity that may be the same or different than the first flow velocity.

In still further embodiments, the present invention is directed to methods of making and using the various fuel cells disclosed herein.

In yet another embodiment, the present invention is directed to a fuel cell that comprises: a first flow-through electrode; a second flow-through electrode spaced apart from the first flow-through electrode; a plenum or flow cell interposed between and contiguous with at least a portion of the first and second flow-through electrodes; a first fluid that passes through the first flow-through electrode and into the plenum or flow cell, wherein the first fluid laminarly flows adjacent to an inner side of the first electrode in a first flow direction; and a second fluid that passes through the second flow-through electrode and into the plenum or flow cell, wherein second fluid laminarly flows adjacent to an inner side of the second electrode in a second flow direction, and wherein the first and second flow directions are different from each other. In this embodiment, the first and second fluids may contact each other to define an interface as the first and second fluids laminarly flow within the plenum or flow cell. Alternatively, the fuel cell may further comprise a separator positioned between the first fluid laminarly flowing adjacent to the first electrode and the second fluid laminarly flowing adjacent to the second electrode. The separator may be a metallic membrane or a polymeric membrane. In addition, the first and second flow directions may range from being perpendicular to each other to being substantially parallel or parallel to each other.

In other embodiments, the first fluid laminarly flowing adjacent to the inner side of the first electrode has a first flow velocity, and the second fluid laminarly flowing adjacent to the inner side of the second electrode has a second flow velocity, and wherein the first and second flow velocities are different from each other. In still other embodiments, the electrochemical cell may further comprise a third fluid that laminarly flows between the first and second fluids, wherein the third flow direction is the same or different than the first flow direction. The third fluid flow has a third flow velocity that may be the same or different than the first flow velocity.

These and other aspects of the several inventive embodiments disclosed herein will become more evident upon reference to the following detailed description and attached drawings. It is to be understood, however, that various changes, alterations, and substitutions may be made to the specific embodiments disclosed herein without departing from their essential spirit and scope. In addition, it is to be further understood that the drawings are intended to be illustrative and symbolic representations of certain exemplary embodiments of the present invention and as such they are not necessarily drawn to scale. Finally, it is expressly provided that all of the various references cited herein are incorporated herein by reference in their entireties for all purposes.

### DETAILED DESCRIPTION OF THE INVENTION

As noted above, the present invention is directed to electrochemical and fuel cell systems having internal laminar flowstreams and, more specifically, to microfluidic electrochemical and fuel cells having two or more adjacent and cross-flowing (i.e., non-parallel) laminar flowstreams positioned within an electrode pair assembly. The space or plenum that exist between the various electrode pair assemblies disclosed herein (i.e., flow-through electrodes and non-flow-through electrodes) are also sometimes referred to as a flow cell. As is appreciated by those skilled in the art, a fuel cell system generally comprises a stack of electrode pair assemblies (commonly referred to as a fuel cell electrode stack assembly), wherein each individual electrode pair assembly consists essentially of two opposing electrode structures, an anode and a cathode, ionically connected together via an interposing electrolyte. The interposing electrolyte of most conventional direct fuel cell systems (e.g., direct methanol fuel cell (DMFC) systems) generally consists of a solid polymer membrane (e.g., NAFION). Electrode pair assemblies having a solid polymer electrolyte (SPE) membrane are commonly referred to as membrane electrode assemblies (MEAs).

In contrast to conventional direct fuel cell systems having MEAs, the electrode pairs and stack assemblies of the present invention generally include a series of microfluidic flow channels and flow cells for flowing reactant flowstreams (i.e., electrolytic fuel and oxidant flowstreams also sometimes referred to herein as anolyte and catholyte flowstreams, respectively) adjacent to and/or through discrete regions of accompanying electrode structures. As used herein, the term “microfluidic” simply refers to an article of manufacture that has one or more flow channels or flow cells with at least one dimension less than about 1 millimeter (mm). Unlike conventional direct fuel cell systems that utilize a SPE membrane as the sole interposing electrolyte (of an electrode pair assembly), the electrode pair assemblies of several embodiments of the present invention utilize “cross-flowing” (i.e., non-parallel) laminar liquid anolyte and catholyte flowstreams that have an acidic electrolyte component (e.g., H₂SO₄ or triflic acid) as the interposing electrolyte (optionally having an additional interposing separator or third laminar electrolyte flowstream). In this way, protons (H⁺) liberated at the anode are able to migrate through the interposing flowing anolyte and catholyte (within the flow cell) and combine with oxidant at the catalyst surface of the opposing cathode to yield reaction products.

The laminar liquid anolyte and catholyte flowstreams of the “cross-flowing” embodiments of the present invention are not considered to be “parallel” to each other (or one another in the case of three laminar flowstreams) because the average directional flow vector or profile associated with each flowstream (of several of the different embodiments disclosed herein) is different from the other, meaning that each adjacent flowstream positioned within an electrode pair assembly (or flow cell) are not everywhere equidistant with respect to the other adjacent flowstream. As such, the opposing and adjacent liquid anolyte and catholyte flowstreams are characterized as being “cross-flowing” in nature (or “cross directional”) and are thus not considered to be parallel to each other.

The dimensions of the electrode pair assemblies, flow cells, and flow channels (delivery and removal) of the present invention are generally configured such that fluid flow is characterized by a low Reynolds number (i.e., Re<˜2,000). As is appreciated by those skilled in the art, the Reynolds number (Rₑ) characterizes the tendency of a flowing liquid phase to develop turbulence and may be expressed by the following Equation (4):
Re=Vdρ/μ (4)
where V is the average linear flow rate (m/s), d is the diameter of the “pipe” (m), ρ is the density of the fluid (kg/m³), and μ is the absolute viscosity of the fluid (Ns/m²). In the context of a flow channel or plenum having a rectangular cross section, the pipe diameter is more appropriately replaced with the hydraulic diameter (Dₕ), which is given by four times the cross-sectional area divided by the perimeter of the flow channel or plenum (i.e., Dₕ=2wh/(w+h) where w and h are the width and height, respectively, of the flow channel or plenum). As used herein, the term “plenum” means a chamber or compartment such as the flow cells disclosed herein, whereas the term “channel” means an enclosed elongated groove or furrow. Thus, the Reynolds number of a plenum or flow channel having a rectangular cross section may more accurately be represented by Equation (5):
   Re=VDₕρ/μ (5)

In view of the foregoing, it is apparent that the lower the velocity (ν) of the liquid flow, the diameter of the pipe or capillary (d), and the density of the liquid (ρ), and the higher the viscosity (μ) of the liquid, the lower the Reynolds number. As is appreciated by those skilled in the art, laminar flow generally occurs in fluidic systems with Re<˜2,000, and turbulent flow generally occurs in fluidic systems with Re>μ2,000 (see, e.g., P. Kenis et al., Microfabrication Inside Capillaries Using Multiphase Laminar Flow Patterning, Science 285:83-85, 1999). Thus, typical widths and heights associated with the microfluidic plenums and flow channels of the present invention generally range from about 10 to about 10,000 μm, preferably from about 50 to about 5,000 μm, and even more preferably from about 100 to about 1,000 μm. In some preferred embodiments, the anode and cathode are confronting and spaced apart a distance of about 50 microns to about 1 millimeter (i.e., ˜1 mm), and preferably from about 100 microns to about 200 microns. In addition, typical Reynolds numbers associated with the internal laminar flowstreams of the present invention are generally less than 1,000, and preferably between 10 and 100. Finally, the flow velocities associated with the internal laminar flowstreams of the present invention generally range from about 2 μm/min to about 100 μm/min, and fluid fluxes (associated with certain flow-through electrode embodiments) generally range from about 10 μm/min/cm² to about 500 μm/min/cm².

In some preferred embodiments, the anolyte flowstream comprises a fuel selected from methanol, ethanol, propanol, or a combination thereof, and the catholyte flowstream comprises an oxidant selected from oxygen, hydrogen peroxide, nitric acid, or a combination thereof. In addition, the electrolyte used in the anolyte, catholyte, and/or electrolyte flowstreams preferably is an acid selected from phosphoric acid, sulfuric acid, trifluoromethane sulfonic acid (triflic acid), difluoromethane diphosphoric acid, difluoromethane disulfonic acid, trifluoroacetic acid, or a combination thereof. In some embodiments, the anolyte flowstream is an approximate 2M MeOH/4M H₂SO₄ liquid fuel/electrolyte mixture, and the catholyte flow stream is an approximate 2M HNO₃/4M H₂SO₄ liquid oxidant/electrolyte flowstream. The molarities of the different chemical constituents associated with the anolyte and catholyte flowstreams, may however, vary substantially from these exemplary values.

Because of the highly corrosive and reactive nature of the chemicals involved with the direct fuel cell systems disclosed herein, the various electrode structures of the present invention are preferably made or derived from a silicon substrate (e.g., a n- or p-type silicon wafer) using microelectromechanical systems (MEMS) technologies such as, for example, wet chemical etching, deep reactive ion etching (DRIE), and hydrofluoric acid (HF) anodic etching as known in the art and as herein disclosed. The electrode structures of the present invention may, however, be made from one or more other materials such as such as, for example, a porous carbon-based material, a porous ceramic material, a porous indium-phosphide material, and/or a sol-gel material (see, e.g., commonly owned PCT International Nos. WO 01/37357, WO 02/086994, WO 03/05873, and U.S. Patent Publication Nos. US2002/0182479, US2003/0194598 which publications are incorporated herein by reference in their entireties).

In several of the embodiments set forth herein, the inventive electrode pair assemblies are based, in large part, on porous flow-through substrates and support structures that have catalyst particles dispersed (contiguously or noncontiguously) on selected pore surfaces. In these embodiments, the surfaced adhered catalyst material is generally readily accessible to flowing gaseous and/or liquid reactant streams. Moreover, and in the context of some embodiments of the present invention, it has been discovered that silicon-based substrates and/or support structures are particularly useful as electrodes for fuel cell systems (especially for microfluidic direct methanol fuel cell systems), in part because such substrates and/or support structures are able to provide a high surface area to bulk volume ratio, have good mechanical strength, and are compatible with thin/thick films which are often needed for making selected electrical connections. Because of these physical characteristic, among others, and because silicon-based substrates and/or support structures are amenable to micro-fabrication techniques, the electrochemical and fuel cells of the present invention may be manufactured within a small form factor, but with sufficient power densities to power portable electronic devices.

Accordingly, and without limitation to any particular methodology, the silicon-based electrode pair assemblies and related flow channels and flow cells disclosed herein may be manufactured by using standard microelectromechanical systems (MEMS) technologies such as, for example, wet chemical etching, deep reactive ion etching (DRIE), hydrofluoric acid (HF) anodic etching, alkaline etching, plasma etching, lithography, and electrodeposition. By using these techniques, a silicon substrate useful for carrying a catalyst may be produced, wherein the silicon substrate may have any number of pores and pores sizes such as, for example, random or ordered pore arrays—including pore arrays having selected pore diameters, depths, and distances relative to one another. In short, the present invention is inclusive of all silicon substrate support structures, including combinations thereof, that have any number of possible porosities and/or void spaces associated therewith.

Thus, the electrode structures of the present invention preferably comprise a silicon substrate (with a thickness preferably ranging from about 300 to about 500 microns) having one or more discrete porous regions disposed across a top surface of the substrate. In addition, each of the one or more discrete porous regions is preferably defined by a plurality of acicular or columnar pores (i.e., passageways) that extend through the substrate (with average diameter ranging from about 0.5 to about 10 microns). The plurality of acicular or columnar pores define inner pore surfaces, and the inner pore surfaces may have an optional conformal electrically conductive layer thereon. In some embodiments, the pores are substantially perpendicular to the top and bottom surfaces of the substrate. In some other embodiments, the pores each have a diameter of about 5 microns and are spaced apart from one another about 8 microns (from pore center axis to adjacent pore center axis) so as to yield substrate having an approximate 39% porosity.

Porous silicon substrates (and/or support structures) useful as electrode structures may be formed by silicon micro-machining and/or wet chemical techniques (employed by the semiconductor industry) such as, for example, anodic polarization of silicon in hydrofluoric acid. As is appreciated by those skilled in the art, the anodic polarization of silicon in hydrofluoric acid (HF) is a chemical dissolution technique and is generally referred to as HF anodic etching. This technique has been used in the semiconductor industry for wafer thinning, polishing, and the manufacture of thick porous silicon films. (See, e.g., Eijkel, et al., “A New Technology for Micromachining of Silicon: Dopant Selective HF Anodic Etching for the Realization of Low-Doped Monocrystalline Silicon Structures,” IEEE Electron Device Ltrs., 11(12):588-589 (1990)). In the context of the present invention, it is to be understood that the porous silicon may be microporous silicon (i.e., average pore size <2 nm), mesoporous silicon (i.e., average pore size of 2 nm to 50 nm), or macroporous silicon (i.e., average pore size >50 nm). The pores are preferably arranged as a series of parallelly aligned acicular or columnar pores that extend into or through the silicon substrate. Although the pores may be angled with respect to top and bottom surfaces of the silicon substrate, they are preferably substantially perpendicular to the top and bottom surfaces of the substrate.

For example, porous silicon substrates useful in the context of the present invention may be formed by a photoelectrochemical HF anodic etching technique, wherein selected oxidation-dissolution of silicon occurs under a controlled current density. (See, e.g., Levy-Clement et al., “Porous n-silicon Produced by Photoelectrochemical Etching,” Applied Surface Science, 65/66: 408-414 (1993); M. J. Eddowes, “Photoelectrochemical Etching of Three-Dimensional Structures in Silicon,” J. of Electrochem. Soc., 137(11):3514-3516 (1990).) An advantage of this relatively more sophisticated technique over others is that it is largely independent of the different principal crystallographic planes associated with single-crystal silicon wafers (whereas most anisotropic wet chemical etching methods have very significant differences in rates of etching along the different principal crystallographic planes).

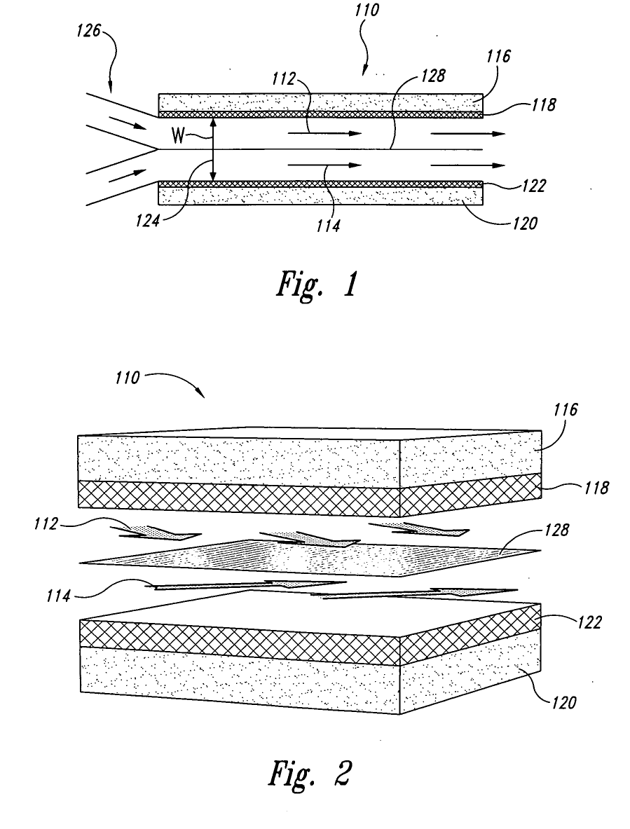

Thus and in view of the foregoing and with reference to FIGS. 1-5B, the present invention in one embodiment is directed to an electrode pair assembly 110 having two internal laminar flowstreams 112, 114. More specifically, the electrode pair assembly 110 in this embodiment is adapted for use with an electrochemical or fuel cell system (not shown), wherein the electrode pair assembly 110 comprises: an anode structure 116 having a first catalyst thereon 118; a flowing liquid fuel/electrolyte mixture (anolyte) 112; a flowing liquid oxidant/electrolyte mixture (catholyte) 114; and a cathode structure 120 having a second catalyst thereon 122. As shown, the anode structure 116 and the cathode structure 120 are preferably confronting and spaced apart and substantially planar parallel to each other so as to define a spaced apart region or plenum 124 (having a selected width, W). In this configuration, the liquid anolyte 112 and catholyte 114 are flowing laminarly between the anode structure 116 and the cathode structure 120. In other words, the liquid fuel/electrolyte mixture 112 generally defines a first laminar flowstream 112 that runs adjacent to the anode structure 116, and the liquid oxidant/electrolyte mixture 114 generally defines a second laminar flowstream 114 that runs adjacent to the cathode structure 120.

As shown in FIG. 1, the fuel cell system (not shown) may in some embodiments further include a Y-shaped channel 126. (Note: in alternative embodiments the Y-shaped channel 126 may be replaced by a T-shaped channel.) The Y-shaped channel 126 allows the anolyte flowstream 112 and the catholyte flowstream 114 to merge and continue to flow laminarly between the opposing walls of the anode structure 116 and the cathode structure 120. In this way, the two liquid laminar flowstreams 112, 114 are in diffusive contact with each other at a fluid interface 128 thereby allowing for H⁺ions (protons) to diffuse across the spaced apart region or plenum (flow cell) 124 of the electrode pair assembly 110 (i.e., diffuse from the first catalyst 118 on the anode structure 116 to the second catalyst 122 on the cathode structure 120).

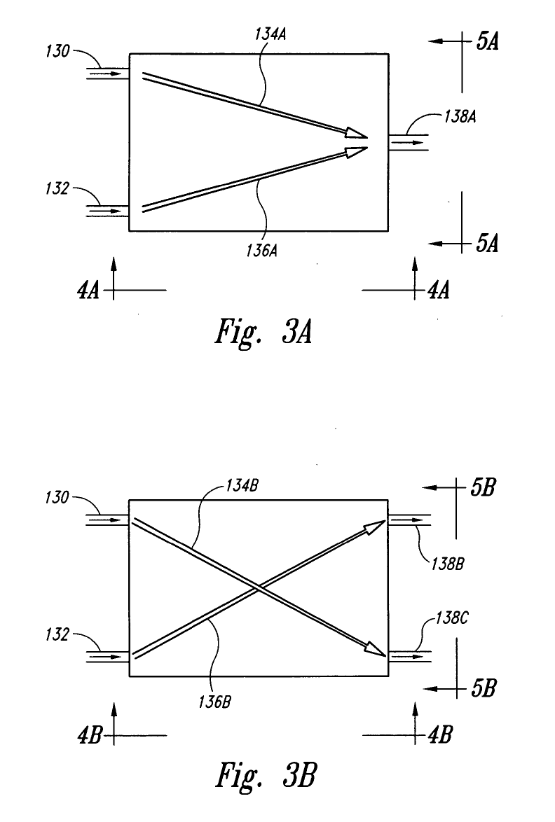

In other preferred embodiments and as best shown in FIGS. 2-5B, the single Y-shaped channel 126 may be replaced by first and second inlet zones 130, 132 configured such that (1) the anolyte 112 passes through the first inlet zone 130, enters the plenum 124 and laminarly flows adjacent to the anode structure 116 in a first average flow direction 134A, 134B (represented by arrows), and (2) the catholyte 114 passes through the second inlet zone 132 enters the plenum 124 and laminarly flows adjacent to the cathode structure 120 in a second average flow direction 136A, 136B (represented by arrows). In these embodiments, the first and second average flow directions 134A-B, 136A-B are generally different from each other. Moreover, the first and second flow average directions 134A-B, 136A-B may range from being perpendicular to each other to being substantially parallel or parallel to each other, depending on the placement and configuration of the first and second inlet zones 130, 132, and depending on whether there is only a first outlet zone 138A (as shown in FIGS. 3A, 4A, and 5A) or first and second outlet zones 138B, 138C (as shown in FIGS. 3B, 4B, and 5B).

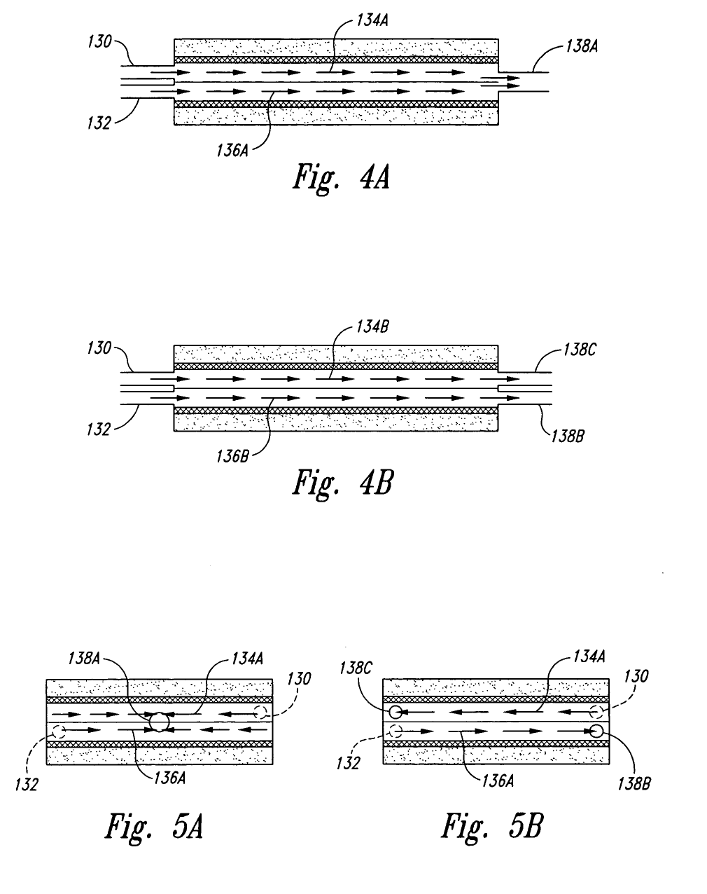

Thus, and as best shown in FIGS. 3A-5B, the present invention may in some embodiments be characterized as an electrochemical cell defined by the electrode pair assembly 110, wherein the electrode pair assembly 110 includes: the anode structure 116; the cathode structure 120 opposing and confronting the anode structure 116; and the plenum 124 interposed between, and contiguous with, at least a portion of the anode and cathode structure 116, 120. As best shown in FIGS. 4A-5B, the anolyte and catholyte 112, 114 contact each other to define the fluid interface 128 as the anolyte and catholyte 112, 114 laminarly flow within the plenum 124. Alternatively, the electrochemical cell may in lieu of the fluid interface 128 further comprise a separator (not shown) positioned between the anolyte 112 laminarly flowing adjacent to the anode structure 116 and the catholyte 114 laminarly flowing adjacent to the cathode structure 120. In other words, the fluid interface 128 may be replaced with a structural separator component. The separator may be a metallic membrane such as, for example, a palladium foil, or a polymeric membrane such as, for example, NAFION; provided, however, that the separator is substantially permeable to H⁺ ions.

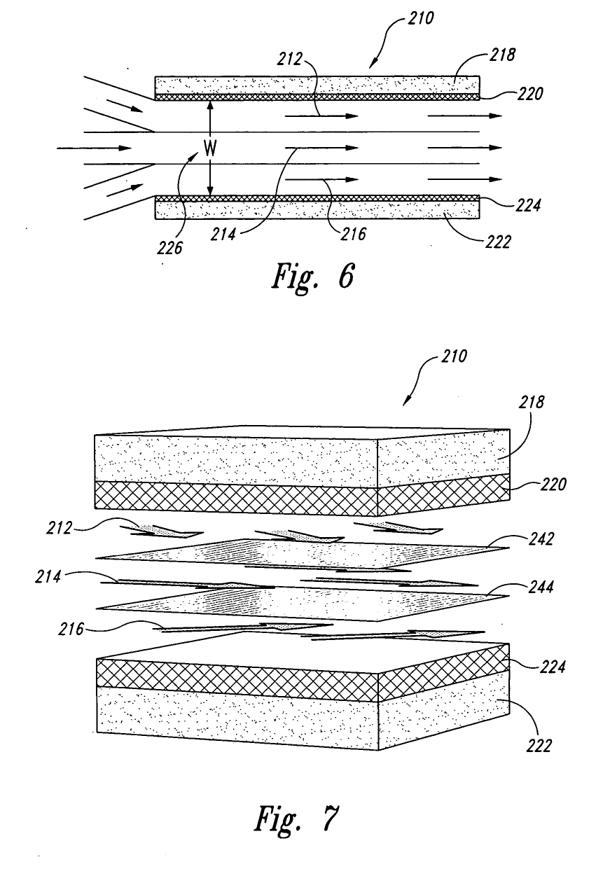

In other embodiments and with reference to FIGS. 6-10B, the present invention is directed to an electrode pair assembly 210 having three internal laminar flowstreams 212, 214, 216. More specifically, the electrode pair assembly 210 in these embodiments are adapted for use with an electrochemical or fuel cell system (not shown), wherein the electrode pair assembly 210 includes: an anode structure 218 having a first catalyst thereon 220; a flowing liquid fuel/electrolyte mixture (anolyte) 212; a flowing electrolyte mixture (electrolyte) 214; a flowing liquid oxidant/electrolyte mixture (catholyte) 216; and a cathode structure 222 having a second catalyst thereon 224. As shown, the anode structure 218 and the cathode structure 222 are preferably confronting and spaced apart and substantially planar parallel to each other so as to define a spaced apart region or plenum 226 (having a selected width, W). In this configuration, the liquid anolyte 212, electrolyte 214, and catholyte 216 are all flowing laminarly between the anode structure 218 and the cathode structure 222.

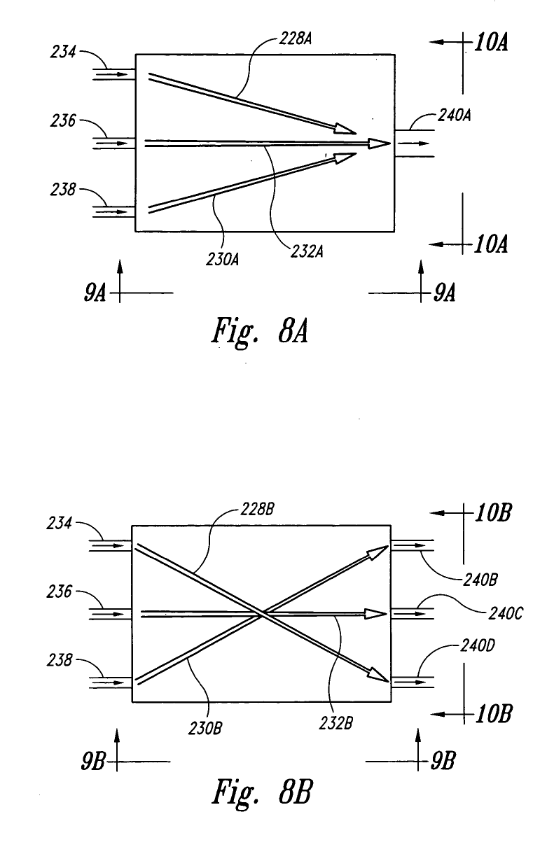

In other words, the liquid fuel/electrolyte mixture 212 generally defines a first laminar flowstream 212 that runs adjacent to the anode structure 218 in a first average flow direction 228A, 228B, the liquid oxidant/electrolyte mixture 216 generally defines a second laminar flowstream 216 that runs adjacent to the cathode structure 222 in a second average flow direction 230A, 230B, and the liquid electrolyte 214 defines a third laminar flowstream 214 that runs between the first and second laminar flowstreams 212, 216 in a third average flow direction 232A, 232B. In these embodiments, at least the first and second average flow directions 228A-B, 230A-B are generally different from each other. Moreover, the first and second average flow directions 228A-B, 230A-B may range from being perpendicular to each other to being substantially parallel or parallel to each other, depending on the placement and configuration of first, second, and third inlet zones 234, 236, 238, and depending on whether there is only a first outlet zone 240A (as shown in FIGS. 8A, 9A, and 10A) or first, second, and third outlet zones 240B, 240C, 240D (as shown in FIGS. 8B, 9B, and 10B).

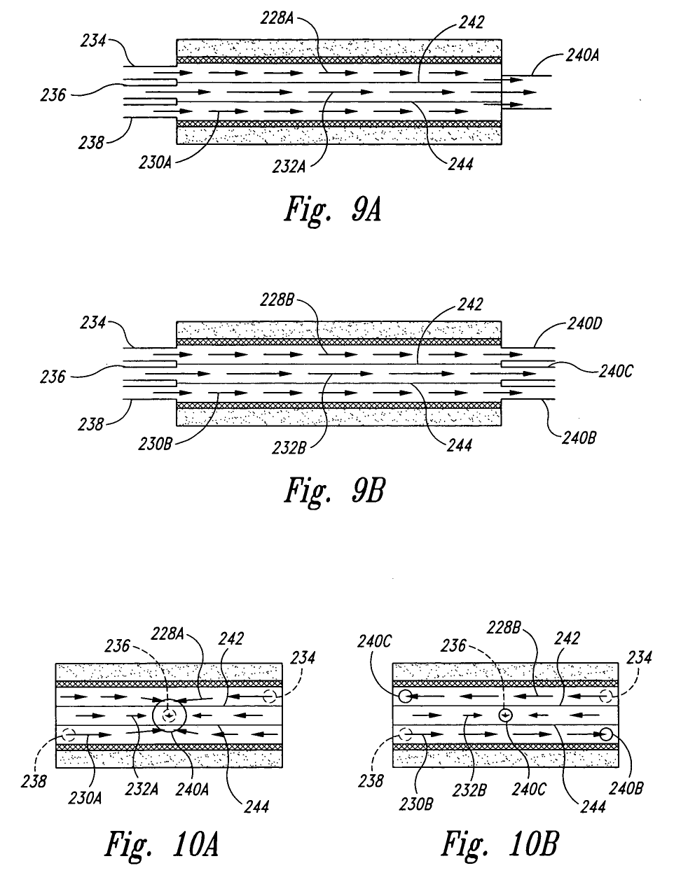

As best shown in FIGS. 9A-9B, the anolyte, electrolyte, and catholyte 212, 214, 216 contact each other to define first and second fluid interfaces 242, 244 as the anolyte, catholyte, and electrolyte 212, 214, 216 laminarly flow within the plenum 226. Alternatively, the electrochemical cell may in lieu of the first and second fluid interfaces 242, 244 further comprise first and second separators (not shown) respectively positioned between the anolyte 212 laminarly flowing adjacent to the anode structure 218, the interposing electrolyte 214, and the catholyte 216 laminarly flowing adjacent to the cathode structure 222. In other words, the first and second fluid interface 242, 244 may be replaced with structural separator components. The separators may be a metallic membrane such as, for example, a palladium foil, and/or a polymeric membrane such as, for example, NAFION; provided, however, that the separator is substantially permeable to H⁺ ions.

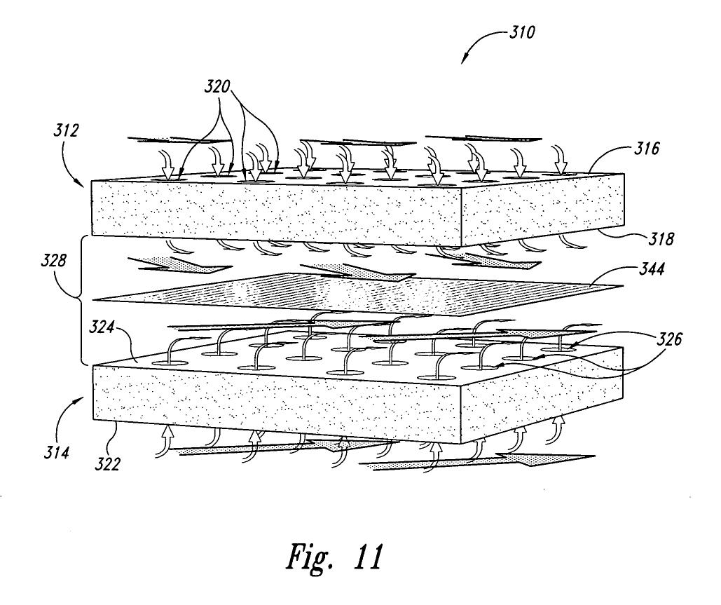

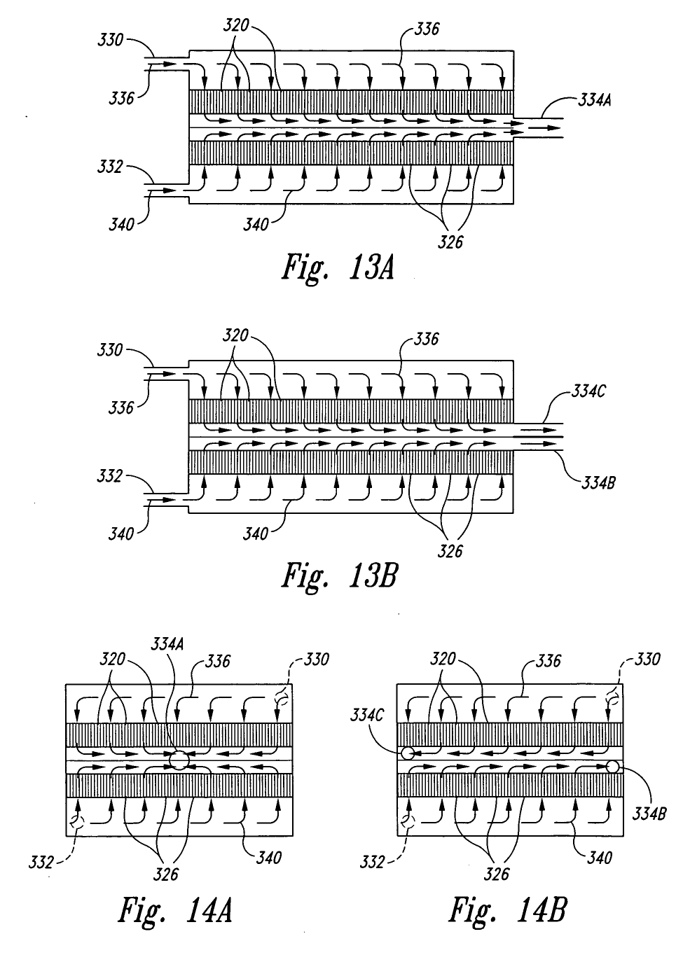

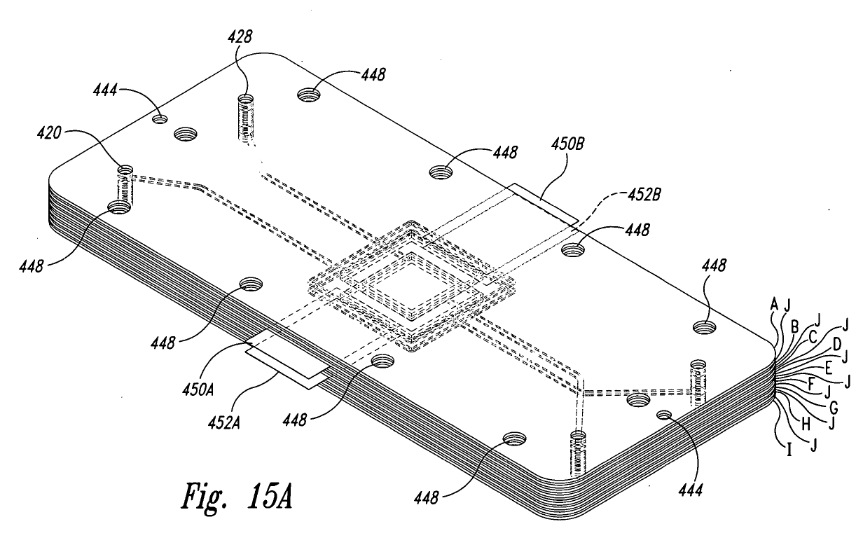

In still other embodiments and with reference to FIGS. 11-14B, the present invention is directed to a fuel cell 310 that includes first and second flow-through electrodes 312, 314. In these embodiments, the first flow-through electrode 312 has an outer side 316 and an inner side 318 with a plurality passageways 320 (e.g., acicular pores) extending from the outer side 316 to the inner side 318. The second flow-through electrode 314 also has an outer side 322 and an inner side 324 also with a plurality of passageways 326 (e.g., acicular pores) extending from the outer side 322 to the inner side 324. As best shown in FIGS. 13A-14B, the second flow-through electrode 314 is spaced apart from the first flow-through electrode 312 such that the inner sides 318, 324 of each flow-through electrode 312, 314 are confronting each other. In addition, a plenum 328 is interposed between, and contiguous with, at least a portion of the inner sides 318, 324 of each flow-through electrode 312, 314.

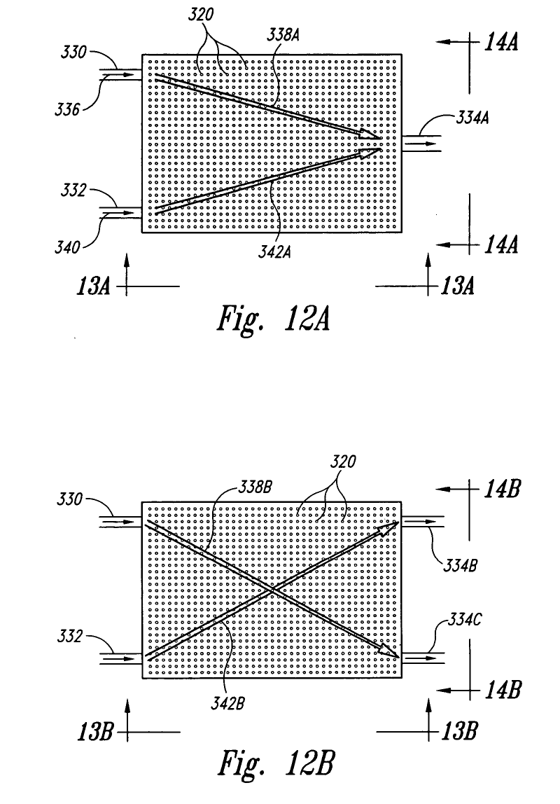

As best shown in FIGS. 12A-14B, a first inlet zone 330 outwardly bounds the outer side 316 of the first flow-through electrode 312, and a second inlet zone 332 outwardly bounds the outer side 322 of the second flow-through electrode 314. In addition, a first outlet zone 334A (as shown in FIGS. 12A, 13A, and 14A), or a first outlet zone and an optional second outlet zone 334B, 334C (as shown in FIGS. 12B, 13B, and 14B) outwardly bound a portion of the inner sides 318, 324 of each flow-through electrode 312, 314. A first fluid flowstream 336 (i.e., liquid reactant/electrolyte mixture or anolyte) enters the first inlet zone 330 and passes through the plurality of passageways 320 of the first flow-through electrode 312 and flows laminarly adjacent to the inner side 318 of the first flow-through electrode 312 in a first average flow direction 338A, 338B (depicted by arrows) and exits through the first outlet zone 334A, or the first and second outlet zones 34B-C (depending of the configuration). Similarly, a second fluid flowstream 340 (i.e., liquid oxidant/electrolyte mixture or catholyte) enters the second inlet zone 332 and passes through the plurality of passageways 326 of the second flow-through electrode 314 and flows laminarly adjacent to the inner side 324 of the second flow-through electrode 314 in a second average flow direction 342A, 342B (depicted by arrows) and exits through the first outlet zone 334A, or the first and second outlet zones 334B, 334C (depending of the configuration). The first and second average flow directions 338A-B, 342A-B are preferably different from each other.

Stated somewhat differently, the anolyte flowstream 336 is flowing and flows through the passageways 320 (e.g., acicular pores) of the first flow-through electrode 312 (and in so doing the reactant (e.g., methanol) is able to react on, for example, surface adhered platinum:ruthenium (Ptₓ:Ru_{y}) catalyst particles that line the pore surfaces) and adjacent to the first flow-through electrode 312 within the plenum 328. Similarly, the catholyte flowstream 340 is flowing and flows through the passageways 326 (e.g., acicular pores) of the second flow-through electrode 314 (and in so doing the oxidant (e.g., nitric acid, hydrogen peroxide, and/or oxygen) is able to react on, for example, surface adhered platinum (Pt) catalyst particles that line the pore surfaces) and adjacent to the second flow-through electrode 314 within the plenum 328. As shown, the anolyte flowstream 336 and the catholyte flowstream 340 flow adjacent and cross-directional with respect to each other within the plenum 328 and merge at the first outlet zone 334A, or (depending on the configuration) the first and optional second outlet zones 334B, 334C. The anolyte flowstream 336 and the catholyte flowstream 340 both generally flow laminarly. In this way, the two liquid laminar flowstreams 336, 340 are allowed to diffusively contact each other at a fluid interface 344 when within the plenum 328 thereby allowing for H⁺ ions to diffuse from the anode-side catalyst particle reaction sites to cathode-side catalyst particle reaction sites. The fluid interface 344 may, however, be replaced with a structural separator component. The separator may be a metallic membrane such as, for example, a palladium foil, or a polymeric membrane such as, for example, NAFION; provided, however, that the separator is substantially permeable to H⁺ ions.

For purpose of illustration and not limitation, the following example more specifically discloses various aspects of the present invention.

### EXAMPLE

### Performance Data Associated with Direct Methanol Fuel Cell Electrode Pair and Stack Assemblies Having Internal Cross-Directional Laminar Flowstreams

Direct methanol fuel cell electrode pair and stack assemblies having internal cross-directional anolyte and catholyte flowstreams were made and tested in the following exemplary manner. First, porous flow-through silicon-based electrode structures used for testing were made as described in commonly owned U.S. Patent Publication No. US2003/0194598.

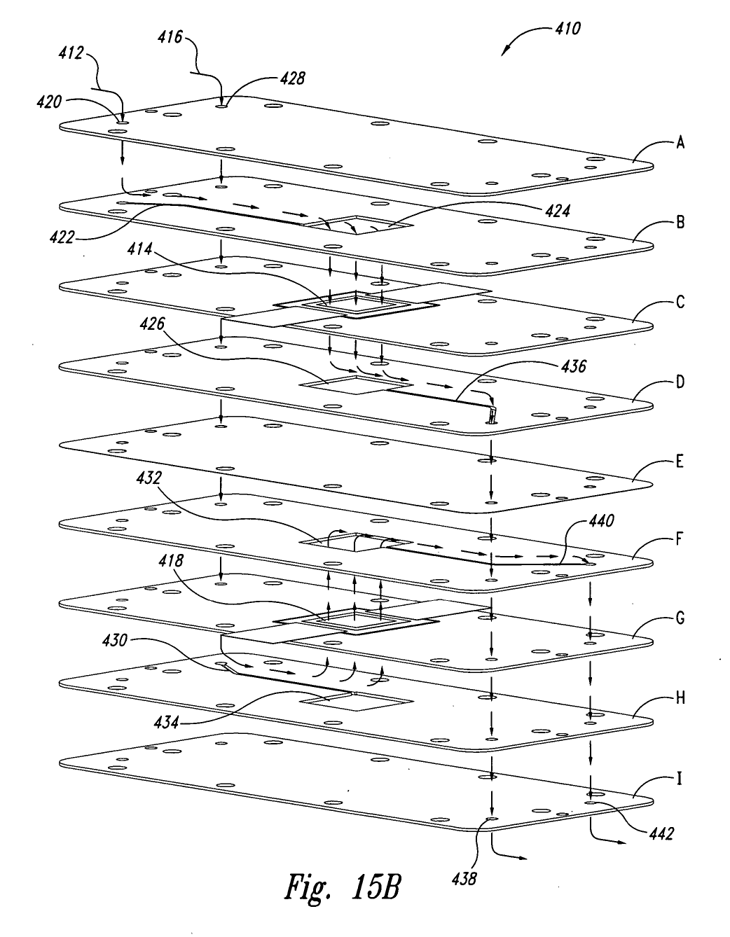

Empirical tests were then run using prototype electrode pair and stack assemblies and configurations. In this regard, silicon-based flow-through anode and cathode 2×2 cm square coupons (i.e., electrodes) were first obtained as described above and then assembled into respective anode and cathode housing structures (i.e., an appropriately configured polycarbonate housing structures as depicted as layers C and G in FIGS. 15A and 15B). The anode and cathode housing structures holding the coupons were then assembled into (1) a 1-cell (i.e., a single pair of electrodes) fuel cell stack as shown in FIGS. 15A and B, and (2) a 4-cell fuel cell stack (not shown).

More specifically, and as shown in FIGS. 15A and B, a fuel cell assembly prototype 410 was constructed to flow (1) and anolyte flowstream 412 through and adjacent to a first porous silicon flow-through electrode 414, and (2) a catholyte flowstream 416 through and adjacent to a second porous silicon flow-through electrode 418 for purposes of testing and design validation. As shown, the anolyte flowstream 412 initially enters a first inlet port 420 and travels along a first inlet channel 422 and then enters a first plenum 424. The anolyte flowstream 412 then passes through the first flow-through electrode 414 and enters a second plenum 426. Similarly, the catholyte flowstream 416 initially enters a second inlet port 428 and travels along a second inlet channel 438 and then enters a third plenum 432. The catholyte flowstream 416 then passes through the second flow-through electrode 418 and enters a fourth plenum 434. A NAFION membrane layer E separates the third plenum 430 from the second plenum 426.

Next, the anolyte flowstream 412 (effluent) enters and travels along a first outlet channel 436 and exits through a first outlet port 438. Similarly, the catholyte flowstream 416 (effluent) enters and travels along a second outlet channel 440 and exits through a second outlet port 442.

The fuel cell assembly prototype 410 was constructed from eight distinct layers A-D, F-I of appropriately machined translucent polycarbonate (sheet or film available from McMaster-Carr, U.S.A.), wherein each opposing polycarbonate layer was bonded together by interposing layers J of silicone-tape (available from Adhesive Research, Inc., U.S.A.) (shown in FIG. 15A, but not shown in exploded view FIG. 15B). In order to properly align the various layers, a pair of opposing alignment holes 444 were used. In addition, a plurality of through-holes 446 were used to secure the various layers together with a plurality of corresponding bolts (not shown). Finally, opposing pairs of protruding gold-plated copper strips 450A-B, 452A-B were attached to the first and second flow-through coupons (electrodes) 414, 418, respectively. The protruding strips 450A-B, 452A-B were used together with appropriate connectors (not shown) to complete an electric circuit between the first and second flow-through electrodes 414, 418.

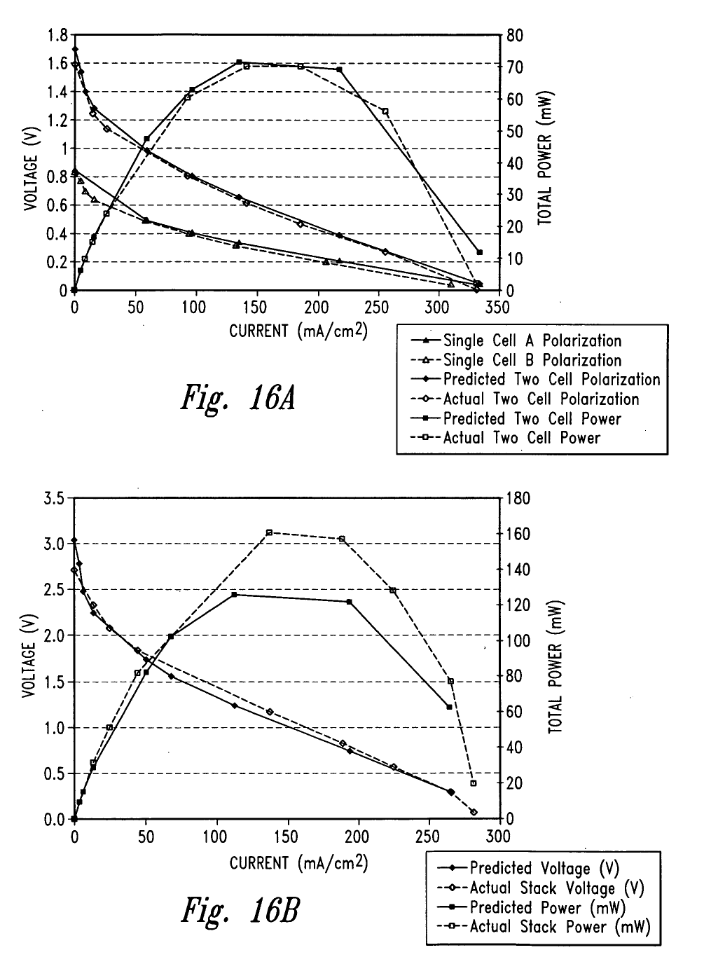

Tests were then run using a 2M MeOH/4M H₂SO₄ anolyte flowstream flowing at about 300 μL/min/cell and a 2M HNO₃/4M H₂SO₄ catholyte flowstream also flowing at about 300 μL/min/cell. Performance data associated with the 1-cell and 4-cell fuel cell stacks are shown in FIGS. 16A and B, respectively. The single cell graphs are repeatable and consistent from cell to cell. The stack graph illustrates that the voltages from each cell add and are similar to the sum of the results from the individual cells.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

1. An electrochemical cell, comprising:
a first electrode;
a second electrode that opposes the first electrode;
a channel or plenum that is interposed between and contiguous with at least a portion of the first and second electrodes;
the electrochemical cell being configured such that a first fluid enters the channel or plenum and laminarly flows adjacent to the first electrode in a first flow direction, and a second fluid enters the channel or plenum and laminarly flows adjacent to the second electrode in a second flow direction, wherein the first and second flow directions are different from each other.

2. The electrochemical cell of claim 1 wherein the first and second fluids contact each other to define an interface as the first and second fluids laminarly flow within the channel or plenum.

3. The electrochemical cell of claim 1, further comprising a separator positioned between the first fluid laminarly flowing adjacent to the first electrode and the second fluid laminarly flowing adjacent to the second electrode.

4. The electrochemical cell of claim 3 wherein the separator is a metallic membrane or a polymeric membrane.

5. The electrochemical cell of claim 1 wherein the first and second flow directions range from perpendicular to each other to substantially parallel to each other.

6. The electrochemical cell of claim 1 wherein the first fluid laminarly flowing adjacent to the first electrode has a first flow velocity, and the second fluid laminarly flowing adjacent to the second electrode has a second flow velocity, and wherein the first and second flow velocities are different from each other.

7. The electrochemical cell of claim 1 wherein the first electrode is an anode and the second electrode is a cathode, and wherein the first fluid is a liquid fuel/electrolyte mixture and the second fluid is a liquid oxidant/electrolyte mixture.

8. The electrochemical cell of claim 7 wherein the liquid fuel/electrolyte mixture comprises a fuel selected from methanol, ethanol, propanol, or a combination thereof.

9. The electrochemical cell of claim 7 wherein the liquid oxidant/electrolyte mixture comprises an oxidant selected from oxygen, hydrogen peroxide, nitric acid, or a combination thereof.

10. The electrochemical cell of claim 7 wherein at least one of the liquid fuel/electrolyte mixture and the liquid oxidant/electrolyte mixture comprises an electrolyte selected from phosphoric acid, sulfuric acid, trifluoromethane sulfonic acid, difluoromethane diphosphoric acid, difluoromethane disulfonic acid, trifluoroacetic acid, or a combination thereof.

11. The electrochemical cell of claim 1, further comprising a third fluid that laminarly flows between the first and second fluids laminarly flowing within the channel or plenum.

12. The electrochemical cell of claim 11 wherein the third fluid laminarly flows in a third flow direction, wherein the third flow direction is the same or different than the first flow direction.

13. The electrochemical cell of claim 6, further comprising a third fluid that laminarly flows between the first and second fluids laminarly flowing within the channel or plenum, wherein the third fluid flow has a third flow velocity, and wherein the third flow velocity is the same or different than the first flow velocity.

14. The electrochemical cell of claim 1 wherein at least one of the first and second electrodes are composed of silicon.

15. The electrochemical cell of claim 1 wherein at least one of the first and second electrodes includes passageways that extend through the electrode.

16. The electrochemical cell of claim 1 wherein at least one of the first and second electrodes has a thickness ranging from about 300 to about 500 microns.

17. The electrochemical cell of claim 1 wherein the channel or plenum has a thickness ranging from about 50 microns to about 1 millimeter.

18. The electrochemical cell of claim 1 wherein the electrochemical cell is a fuel cell.

19. An electrochemical cell, comprising:
a first flow-through electrode;
a second flow-through electrode spaced apart from the first flow-through electrode;
a plenum interposed between and contiguous with at least a portion of the first and second flow-through electrodes;
a first fluid that passes through the first flow-through electrode and into the plenum, wherein the first fluid laminarly flows adjacent to the first electrode in a first flow direction; and
a second fluid that passes through the second flow-through electrode and into the plenum, wherein second fluid laminarly flows adjacent to the second electrode in a second flow direction, and wherein the first and second flow directions are different from each other.

20. The electrochemical cell of claim 19 wherein the first and second fluids contact each other to define an interface as the first and second fluids laminarly flow within the plenum.

21. The electrochemical cell of claim 19, further comprising a separator positioned between the first fluid laminarly flowing adjacent to the first flow-through electrode and the second fluid laminarly flowing adjacent to the second flow-through electrode.

22. The electrochemical cell of claim 21 wherein the separator is a metallic membrane or a polymeric membrane.

23. The electrochemical cell of claim 19 wherein the first and second flow directions range from perpendicular to each other to substantially parallel to each other.

24. The electrochemical cell of claim 19 wherein the first fluid laminarly flowing adjacent to the first flow-through electrode has a first flow velocity, and the second fluid laminarly flowing adjacent to the second flow-through electrode has a second flow velocity, and wherein the first and second flow velocities are different from each other.

25. The electrochemical cell of claim 19 wherein the first flow-through electrode is an anode having a first porous region and the second flow-through electrode is a cathode having a second porous region, and wherein the first fluid is a liquid fuel/electrolyte mixture and the second fluid is a liquid oxidant/electrolyte mixture.

26. The electrochemical cell of claim 25 wherein the liquid fuel/electrolyte mixture comprises a fuel selected from methanol, ethanol, propanol, or a combination thereof.

27. The electrochemical cell of claim 25 wherein the liquid oxidant/electrolyte mixture comprises an oxidant selected from oxygen, hydrogen peroxide, nitric acid, or a combination thereof.

28. The electrochemical cell of claim 25 wherein at least one of the liquid fuel/electrolyte mixture and the liquid oxidant/electrolyte mixture comprises an electrolyte selected from phosphoric acid, sulfuric acid, trifluoromethane sulfonic acid, difluoromethane diphosphoric acid, difluoromethane disulfonic acid, trifluoroacetic acid, or a combination thereof.

29. The electrochemical cell of claim 19, further comprising a third fluid that laminarly flows between the first and second fluids laminarly flowing within the plenum.

30. The electrochemical cell of claim 29 wherein the third fluid laminarly flows in a third flow direction, wherein the third flow direction is the same or different than the first flow direction.

31. The electrochemical cell of claim 24, further comprising a third fluid that laminarly flows between the first and second fluids laminarly flowing within the plenum, wherein the third fluid has a third flow velocity, and wherein the third flow velocity is the same or different than the first flow velocity.

32. The electrochemical cell of claim 19 wherein at least one of the first and second flow-through electrodes are composed of silicon.

33. The electrochemical cell of claim 19 wherein the electrochemical cell is a fuel cell.

34. The electrochemical cell of claim 33 wherein at least one of the first and second flow-through electrodes is defined by a substantially planar silicon substrate having one or more discrete porous regions.

35. The electrochemical cell of claim 19 wherein at least one of the first and second electrodes has a thickness ranging from about 300 to about 500 microns.

36. The electrochemical cell of claim 19 wherein the plenum has a thickness ranging from about 50 microns to about 1 millimeter.

37. A fuel cell, comprising:
a first flow-through electrode having an outer side and an inner side, the first flow-through electrode including a plurality passageways extending from the outer side to the inner side;
a second flow-through electrode having an outer side and an inner side, the second flow-through electrode including a plurality of passageways extending from the outer side to the inner side, the second flow-through electrode being spaced apart from the first flow-through electrode such that the inner sides of each flow-through electrode are confronting each other;
a plenum interposed between and contiguous with at least a first portion of the inner sides of each flow-through electrode;
a first inlet zone outwardly bounding the outer side of the first flow-through electrode;
a second inlet zone outwardly bounding the outer side of the second flow-through electrode;
an outlet zone outwardly bounding a second portion of the inner sides of each flow-through electrode;
a first fluid flowstream; and
a second fluid flowstream;
wherein the first fluid flowstream enters the first inlet zone and passes through the plurality of passageways of the first flow-through electrode and flows laminarly adjacent to the inner side of the first flow-through electrode in a first flow direction and exits through the outlet zone, wherein the second fluid flowstream enters the second inlet zone and passes through the plurality of passageways of the second flow-through electrode and flows laminarly adjacent to the inner side of the second flow-through electrode in a second flow direction and exits through the outlet zone, and wherein the first and second flow directions are different from each other.

38. The fuel cell of claim 37 wherein the first and second fluid flowstreams contact each other to define an interface as the first and second fluids flowstreams laminarly flow within the plenum.

39. The fuel cell of claim 37, further comprising a separator positioned between the first fluid flowstream laminarly flowing adjacent to the inner side of first flow-through electrode and the second fluid flowstream laminarly flowing adjacent to the inner side of the second flow-through electrode.

40. The fuel cell of claim 39 wherein the separator is a metallic membrane or a polymeric membrane.

41. The fuel cell of claim 37 wherein the first and second flow directions range from perpendicular to each other to substantially parallel to each other.

42. The fuel cell of claim 37 wherein the first fluid flowstream laminarly flowing adjacent to the inner side of first flow-through electrode has a first flow velocity, and the second fluid laminarly flowing adjacent to the inner side of the second flow-through electrode has a second flow velocity, and wherein the first and second flow velocities are different from each other.

43. The fuel cell of claim 37 wherein the first flow-through electrode is an anode and the second flow-through electrode is a cathode, and wherein the first fluid is a liquid fuel/electrolyte mixture and the second fluid is a liquid oxidant/electrolyte mixture.

44. The fuel cell of claim 43 wherein the liquid fuel/electrolyte mixture comprises a fuel selected from methanol, ethanol, propanol, or a combination thereof.

45. The fuel cell of claim 43 wherein the liquid oxidant/electrolyte mixture comprises an oxidant selected from oxygen, hydrogen peroxide, nitric acid, or a combination thereof.

46. The fuel cell of claim 43 wherein at least one of the liquid fuel/electrolyte mixture and the liquid oxidant/electrolyte mixture comprises an electrolyte selected from phosphoric acid, sulfuric acid, trifluoromethane sulfonic acid, difluoromethane diphosphoric acid, difluoromethane disulfonic acid, trifluoroacetic acid, or a combination thereof.

47. The fuel cell of claim 37, further comprising a third fluid flowstream that laminarly flows between the first and second fluid flowstreams laminarly flowing within the plenum.

48. The fuel cell of claim 47 wherein the third fluid flowstream laminarly flows in a third flow direction, wherein the third flow direction is the same or different than the first flow direction.

49. The fuel cell of claim 42, further comprising a third fluid flowstream that laminarly flows between the first and second fluids laminarly flowing within the plenum, wherein the third fluid flowstream has a third flow velocity, and wherein the third flow velocity is the same or different than the first flow velocity.

50. The fuel cell of claim 37 wherein at least one of the first and second flow-through electrodes are composed of silicon.

51. The fuel cell of claim 37 wherein at least one of the first and second flow-through electrodes is defined by a substantially planar silicon substrate.

52. The fuel cell of claim 37 wherein the plurality of passageways of the first or second flow-through electrode are defined by a plurality of acicular pores.

53. The fuel cell of claim 52 wherein the plurality of acicular pores are substantially perpendicular with respect to the outer and inner sides of the first or second flow-through electrode.

54. The fuel cell of claim 52 wherein the plurality of acicular pores are angled with respect to the outer and inner sides of the first or second flow-through electrode.

55. The fuel cell of claim 37 wherein at least one of the first and second flow-through electrodes has a thickness ranging from about 300 to about 500 microns.

56. The fuel cell of claim 37 wherein the plenum has a thickness ranging from about 50 microns to about 1 millimeter.
